(19) United States
(12) Patent Application Publication
(10) Pub. No.: US 2011/0233478 A1
(43) Pub. Date: Sep. 29, 2011

(54) SILICON FOR N-TYPE SOLAR CELLS AND A METHOD OF PRODUCING PHOSPHORUS-DOPED SILICON

(75) Inventors: Tomohiro Megumi, Ehime (JP); Hiroshi Tabuchi, Ibaraki (JP); Koichi Kamisako, Tokyo (JP); Marwan Dhamrin, Tokyo (JP)

(73) Assignees: SUMITOMO CHEMICAL COMPANY, LIMITED, Tokyo (JP); TOKYO UNIVERSITY OF AGRICULTURE AND TECHNOLOGY, Fuchu-shi, Tokyo (JP)

(21) Appl. No.: 13/132,019

(22) PCT Filed: Nov. 30, 2009
(86) PCT No.: PCT/JP2009/070114

§ 371 Date: May 31, 2011

(30) Foreign Application Priority Data
Dec. 1, 2008 (JP) 2008-306760
Apr. 16, 2009 (JP) 2009-099604
Sep. 18, 2009 (JP) 2009-217597

(51) Int. Cl. H01B 1/04

(52) U.S. Cl. 252/501.1; 257/E31.002

(57) ABSTRACT

It is an object of the present invention to provide aluminum-containing silicon for n-type solar cells. It further provides a method of producing phosphorous-doped silicon refined form aluminum-containing silicone from an economical point of view. It provides silicon for n-type solar cells containing aluminum at a mass concentration of from 0.001 to 1.0 ppm and phosphorous at a mass concentration of from 0.0011 to 1.1 ppm, and having a mass concentration ratio of phosphorous to aluminum of 1.1 or greater. It further provides a method of producing phosphorous-doped silicon, including: preparing a melted mixture containing aluminum, phosphorous, and silicon, by heating and melting aluminum-containing silicon to obtain a melted product and adding phosphorous to the obtained melted product, or by adding phosphorous to aluminum-containing silicon to obtain a mixture and heating and melting the obtained mixture; and then solidifying the melted mixture in a mold under a temperature gradient in one direction.

### TECHNICAL FIELD

The present invention relates first to silicon for n-type solar cells and second to a method of producing phosphorus-doped silicon, and more specifically, it relates to silicon containing aluminum and phosphorus at specific concentrations and being suitable for use in n-type solar cells, and to a method of producing phosphorus-doped silicon.

### BACKGROUND ART

Phosphorus-doped silicon obtained by adding phosphorus to silicon is an n-type semiconductor, and is useful as a raw material for solar cells. Such phosphorus-doped silicon can be produced by adding phosphorus to heated and melted silicon. Such phosphorus-doped silicon can also be produced by adding phosphorus to silicon to obtain a mixture, and heating and melting the obtained mixture.

Meanwhile, as a method of producing silicon, a method of reducing a silicon halide with metal aluminum is known (see, e.g., Patent Document 1). There is a possibility that the reduced silicon obtained by such a method may contain aluminum as an impurity. Further, when the reduced silicon contains aluminum, the reduced aluminum-containing silicon shows p-type characteristics, and it cannot be said that its solar cell characteristics are excellent. Thus, it is difficult to use the reduced aluminum-containing silicon without modification as a raw material for solar cells. Accordingly, for example, the reduced aluminum-containing silicon may possibly be used after refinement by a “directional solidification method”, for example, in which the above reduced aluminum-containing silicon was heated and melted; the resulting product was solidified in a mold in the state where a temperature gradient is provided in one direction; and the region was removed where aluminum is concentrated as a result of segregation.

In addition, there is not known aluminum-containing silicon for n-type solar cells, which is produced by a directional solidification method. There is also not known a method of adding phosphorus to refined reduced silicon.

### PRIOR ART DOCUMENTS

### Patent Document

Patent Document 1: Japanese Patent Laid-open Publication No. 2-64006

### SUMMARY OF THE INVENTION

### Problems to be Solved by the Invention

It is an object of the present invention to provide aluminum-containing silicon for n-type solar cells.

It is another object of the present invention to provide a method of producing phosphorus-doped silicon refined from aluminum-containing silicon from an economical point of view.

### Means of Solving the Problems

The present inventors have intensively studied to solve the above problems, and as a result, they have obtained the following findings:

(a) When phosphorus is added to heated and melted aluminum-containing silicon before or after refinement by a directional solidification method, refined phosphorus-doped silicon is obtained.

(b) In particular, when phosphorus-doped silicon is solidified in one direction after phosphorus has been added thereto, in the solidified silicon, impurities such as aluminum are segregated from the region placed on the lower temperature side of a temperature gradient to the region placed on the higher temperature side in a cooling process, whereas the distribution of phosphorus shows a relatively small segregation.

(c) When heated and melted aluminum-containing silicon is refined by a directional solidification method, if phosphorus is added so that a mass concentration ratio of phosphorus to aluminum in silicon is 0.009 or greater, silicon for n-type solar cells is obtained after the refinement by the directional solidification method.

(d) In particular, silicon for n-type solar cells containing aluminum at a mass concentration of from 0.001 to 1.0 ppm and phosphorus at a mass concentration of from 0.0011 to 1.1 ppm, and having a mass concentration ratio of phosphorus to aluminum of 1.1 or greater is useful as a raw material for solar cells.

The present invention has been completed by these findings.

That is, the silicon for n-type solar cells according to the present invention has the following constituents:

(1) Silicon for n-type solar cells, containing aluminum at a mass concentration of from 0.001 to 1.0 ppm and phosphorous at a mass concentration of from 0.0011 to 1.1 ppm, and having a mass concentration ratio of phosphorus to aluminum of 1.1 or greater.

(2) The silicon as described in above (1), which is obtained by adding phosphorous to aluminum-containing silicon so that a mass concentration ratio of phosphorous to aluminum becomes 0.009 or greater, to obtain a mixture; heating and melting the obtained mixture to obtain a melted mixture; and solidifying the obtained melted mixture in a mold under a temperature gradient in one direction.

(3) The silicon as described in above (1), which is obtained by heating and melting aluminum-containing silicon to obtain a melted product; adding phosphorous to the obtained melted product so that a mass concentration ratio of phosphorous to aluminum becomes 0.009 or greater, to obtain a melted mixture; and solidifying the obtained melted mixture in a mold under a temperature gradient in one direction.

Further, the method of producing phosphorous-doped silicon according to the present invention has the following constitutions:

(4) A method of producing phosphorous-doped silicon, comprising:

preparing a melted mixture containing aluminum, phosphorous, and silicon, by heating and melting aluminum-containing silicon to obtain a melted product and then adding phosphorous to the obtained melted mixture, or by adding phosphorous to aluminum-containing silicon to obtain a mixture and then heating and melting the obtained mixture; and

then solidifying the melted mixture in a mold under a temperature gradient in one direction.

(5) The method as described in above (4), wherein phosphorous is added so that a mass concentration ratio of phosphorous to aluminum becomes 0.009 or greater in the preparation of the melted mixture.

(6) The method as described in above (4) or (5), wherein the aluminum-containing silicon is reduced silicon obtained by reducing a silicon halide with metal aluminum.

10-(7) The method as described in any of above (4) to (6), wherein the aluminum-containing silicon is subjected to acid washing, and then heated and melted.

(8) The method as described in any of above (4) to (7), wherein the aluminum-containing silicon is heated and melted under reduced pressure.

(9) The method as described in any of above (4) to (8), wherein the aluminum-containing silicon is silicon refined by solidification in one direction.

### EFFECTS OF THE INVENTION

According to the present invention, aluminum-containing silicon for n-type solar cells can easily be produced. That is, when aluminum-containing silicon is refined by a directional solidification method, an appropriate amount of phosphorus determined in accordance with the aluminum content of the silicon may be added. This makes it possible to produce silicon for n-type solar cells, which is useful as a raw material for solar cells, even from aluminum-containing silicon showing p-type characteristics.

In addition, according to the present invention, refined phosphorus-doped silicon can easily be obtained. In particular, a method of heating and melting aluminum-containing silicon to obtain a melted product; adding phosphorus to the obtained melted product; and refining the resulting product by solidifying it in one direction, requires a smaller number of heating and melting processes than a method of heating and melting aluminum-containing silicon; refining the resulting product by solidifying it in one direction; and then heating and melting the obtained refined silicon again; and adding phosphorus to the resulting product. This makes it possible to produce phosphorus-doped silicon from an economical point of view.

### BRIEF DESCRIPTION OF THE DRAWINGS

FIG. 1 (a) and (b) are schematic views showing the steps of obtaining reduced silicon according to one embodiment of the present invention.

FIG. 2 It is a schematic view for explanation showing a directional solidifying method according to one embodiment of the present invention.

FIG. 3 (a) and (b) are schematic views showing the steps of obtaining aluminum-containing silicon for n-type solar cells and phosphorous-doped silicon.

### MODE FOR CARRYING OUT THE INVENTION

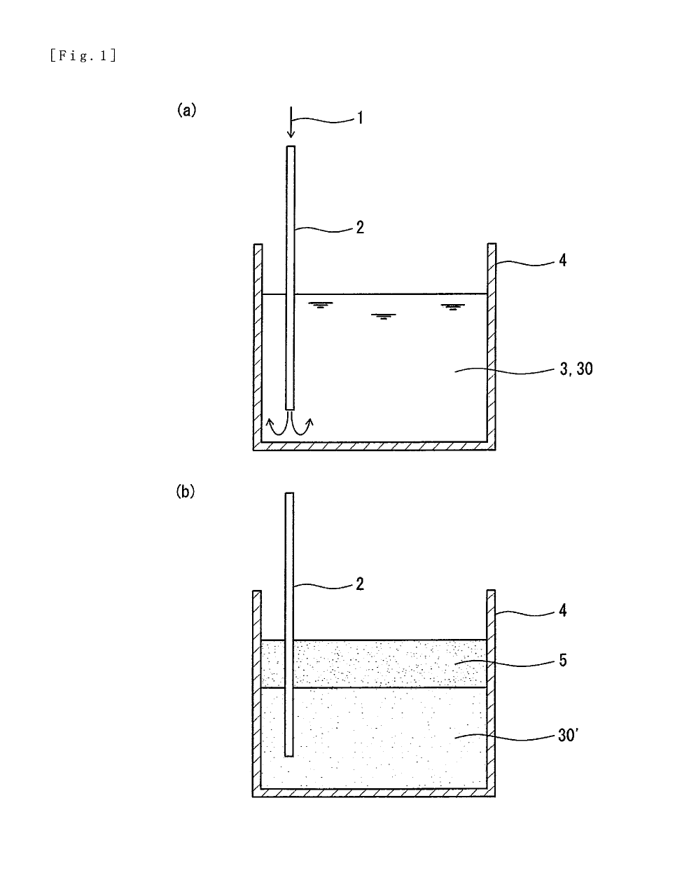

Referring to FIGS. 1 to 3, an embodiment of aluminum-containing silicon for n-type solar cells and a method of producing phosphorus-doped silicon, according to the present invention, will be described below in detail, taking an example the case where reduced silicon is used as aluminum-containing silicon.

The aluminum-containing silicon for n-type solar cells according to the present embodiment is obtained by adding phosphorus to aluminum-containing silicon, and refining the resulting product by directional solidification. Examples of the aluminum-containing silicon may include reduced silicon obtained by reducing a silicon halide with metal aluminum. The reduced silicon can be obtained as follows: That is, as shown in FIG. 1(a), a silicon halide (1) is reduced with metal aluminum (3), and as shown in FIG. 1(b), reduced silicon (5) is obtained. Examples of the silicon halide (1) may include compounds of the following general formula (i).

[Chemical Formula 1]

SiHₙX₄₋ₙ (i)

where n is an integer of from 0 to 3, and X is a halogen atom]

In the above general formula (i), examples of the halogen atom represented by X may include a fluorine atom, a chlorine atom, a bromine atom, and an iodine atom. Examples of the silicon halide compound (i) may include silicon tetrafluoride, silicon trifluoride, silicon difluoride, silicon monofluoride, silicon tetrachloride, silicon trichloride, silicon dichloride, silicon monochloride, silicon tetrabromide, silicon tribromide, silicon dibromide, silicon monobromide, silicon tetraiodide, silicon triiodide, silicon diiodide, and silicon monoiodide.

The purity of the silicon halide (1) may preferably be 99.99% by mass or greater, more preferably 99.9999% by mass or greater, and still more preferably 99.99999% by mass or greater, in order to obtain high-purity silicon for n-type solar cells and high-purity phosphorus-doped silicon. Further, the silicon halide (1) having a small boron content may preferably be used, considering that the obtained phosphorus-doped silicon is used as silicon for n-type solar cells. Specifically, the boron content of the silicon halide (1) may preferably 0.3 ppm or smaller, more preferably 0.1 ppm or smaller, and still more preferably 0.01 ppm or smaller, by the mass ratio of boron to silicon. The boron content can be measured by inductively coupled plasma mass spectrometry (ICP mass spectrometry).

The phosphorus content of the silicon halide (1) may be 3 ppm or smaller, preferably 1 ppm or smaller, by the mass ratio of phosphorus to silicon. When the phosphorus content is greater than 3 ppm, the phosphorus content in the silicon for n-type solar cells as described later may exceed a permissible content taking solar cell characteristics into consideration. The phosphorus content can be measured by ICP mass spectrometry or glow discharge mass spectrometry (GDMS).

As the metal aluminum (3), there may be preferred electrolytically-reduced aluminum commercially available as aluminum; and high-purity aluminum obtained by refining electrolytically-reduced aluminum with a method such as a segregation solidification method and a three-layer electrolytic method.

In addition, the purity of the metal aluminum (3) may preferably be 99.9% by mass or greater, more preferably 99.95% by mass or greater, in order to obtain silicon for n-type solar cells and phosphorus-doped silicon, both of which have little impurity contamination. The purity of metal aluminum is the value obtained by deducting the total content of iron, copper, gallium, titanium, nickel, sodium, magnesium, and zinc from 100% by mass of metal aluminum, and the total content of these impurity elements can be measured by GDMS. As the metal aluminum, there can also be used metal aluminum having a relatively small content of silicon.

To reduce the silicon halide (1) with the metal aluminum (3), for example, the silicon halide (1) may be blown into the heated and melted metal aluminum (3). The reduction of the silicon halide (1) with the metal aluminum (3) by this method makes it possible to obtain the desired aluminum-containing silicon. Specifically, as shown in FIG. 1(a), the silicon halide (1) in a gaseous state is blown into the heated and melted metal aluminum (3) through a blowing pipe (2).

As the blowing pipe (2), there may be preferred one which is inert to the heated and melted metal aluminum (3), and which have heat resistance. Specifically, the blowing pipe (2) may preferably be formed, for example, of carbon such as graphite, silicon carbide, carbon nitride, alumina (aluminum oxide), or silica (silicon oxide) such as quartz.

The heated and melted metal aluminum (3) is held in a container (4). As the container (4), there may be preferred one which is inert to the heated and melted metal aluminum (3), the silicon halide (1), and silicon, and which have heat resistance. Specifically, the container (4) may preferably be formed, for example, of carbon such as graphite, silicon carbide, carbon nitride, alumina (aluminum oxide), or silica (silicon oxide) such as quartz.

When the silicon halide (1) is blown through the blowing pipe (2) into the heated and melted metal aluminum (3) held in the container (4), the silicon halide (1) is reduced to silicon with the metal aluminum (3), and also the produced silicon is dissolved in the metal aluminum (3). This provides aluminum melt (30) containing silicon. The silicon content of the aluminum melt (30) can be adjusted by the amount of silicon halide (1) to be blown.

When the aluminum melt (30) obtained by blowing the silicon halide (1) is cooled, the dissolved silicon is, as shown in FIG. 1(b), crystallized as the reduced silicon (5) on the upper surface of a solid product (30′) obtained by the cooling. It is possible to obtain the desired reduced silicon (5) as aluminum-containing silicon by cutting out the crystallized reduced silicon (5) from the solid product (30′) obtained by the cooling, using, for example, a diamond cutter.

The purity of the obtained reduced silicon (5) may preferably be 94% by mass or greater, more preferably 99.9% by mass or greater, and still more preferably 99.99% by mass or greater. Further, the aluminum content may preferably 52,000 ppm or smaller, more preferably 1,100 ppm or smaller, and still more preferably 12 ppm or smaller, by the mass ratio of aluminum to silicon. The boron content may preferably be 0.15 ppm or smaller, more preferably 0.01 ppm or smaller, by the mass ratio of boron to silicon. The phosphorus content may preferably be 3 ppm or smaller, more preferably 1 ppm or smaller, by the mass ratio of phosphorus to silicon. The carbon content may preferably be 9 ppm or smaller, and more preferably 1 ppm or smaller, by the mass ratio of carbon to silicon. The reduced silicon (5) having such a purity can be obtained, for example, by cooling the aluminum melt (30) at a relatively slow cooling rate. The aluminum and boron contents can be measured by ICP mass spectrometry. The phosphorus content can be measured by ICP mass spectrometry or GDMS. The carbon content can be measured by Fourier transform infrared spectroscopy (FT-IR).

In particular, taking into consideration the use as silicon for n-type solar cells, the purity of the reduced silicon (5) may preferably be 98% by mass or greater, more preferably 99.9% by mass or greater, and still more preferably 99.999% by mass or greater. Further, the aluminum content may preferably be 1% by mass or smaller, more preferably 1,000 ppm or smaller, and still more preferably 10 ppm or smaller, by the mass ratio of aluminum to silicon. The phosphorus content may preferably be 3 ppm or smaller, more preferably 1 ppm or smaller, by the mass ratio of phosphorus to silicon. A decrease in the purity of the reduced silicon (5) may increase the number of refinement processes by directional solidification, which are carried out until the production of silicon for n-type solar cells. Accordingly, when the purity of the reduced silicon (5) is smaller than 98% by mass, or when the aluminum content is greater than 1% by mass by the mass ratio of aluminum to silicon, or when the phosphorus content is greater than 3 ppm, it may become difficult to use refinement by a directional solidification method from industrial and economical points of view.

To the surface of the obtained reduced silicon (5), metal aluminum may be attached. Further, the obtained reduced silicon (5) may contain impurities other than aluminum, depending on the purities and other factors of the silicon halide (1) and the metal aluminum (3), which have been used. In such cases, the reduced silicon (5) may preferably be washed with an acid to remove impurities such as aluminum, and then may preferably be subjected to the subsequent heating and melting process as described later.

The acid washing of the reduced silicon (5) can be carried out, for example, by immersing the reduced silicon (5) in an acid. Examples of the acid to be used for acid washing may include concentrated nitric acid, concentrated hydrochloric acid, and aqua regia. An appropriate acid washing temperature may usually be from 20° C. to 90° C. An appropriate acid washing time may usually be from 5 hours to 24 hours, and preferably from 5 hours to 12 hours.

Then, the obtained reduced silicon (5), which is aluminum-containing silicon, is heated and melted. The heating and melting of the reduced silicon (5) may be carried out under atmospheric pressure, but may preferably be carried out under reduced pressure. This makes it possible to volatilize and remove volatile impurity elements from the reduced silicon (5). The pressure (absolute pressure) for heating and melting under reduced pressure may usually be 400 Pa or lower, preferably 100 Pa or lower, and more preferably 0.5 Pa or lower. The heating temperature for the heating and melting of the reduced silicon (5) may be at or above the melting temperature of the reduced silicon (5), and may usually be from 1,410° C. to 1,650° C.

Then, phosphorus is added to the heated and melted reduced silicon (5). The amount of phosphorus to be added may appropriately be selected depending on the content of phosphorus contained in the reduced silicon (5), the degree of segregation of phosphorus in a solidification process as described later, and the phosphorus content of the desired phosphorus-doped silicon. Phosphorus may preferably be added so that the amount of phosphorus to be added is greater than the boron content and is usually from 0.02 to 3 ppm, preferably from 0.03 to 1 ppm, by the mass ratio of phosphorus to silicon. In this connection, phosphorus may be added before the heating and melting.

In particular, taking into consideration the use as silicon for n-type solar cells, phosphorus is added so that the amount of phosphorus to be added may be 0.009 or greater, preferably from 0.009 to 1.5, by the mass concentration ratio of phosphorus to aluminum in silicon, depending on the content of aluminum contained in the aluminum-containing silicon. It is not desirable that the amount of phosphorus to be added may be smaller than 0.009 by the mass concentration ratio of phosphorus to aluminum because the obtained refined silicon becomes difficult to show n-type characteristics and the yield of the obtained silicon for n-type solar cells is also decreased.

As the phosphorus, a silicon-phosphorus master alloy may usually be added, the silicon-phosphorus master alloy being an alloy of high-purity silicon having a purity of 99.99999% by mass (seven nines) or greater and high-purity phosphorus having a purity of 99.9999% by mass (six nines) or greater. Examples of the silicon-phosphorus master alloy may include those having a resistivity of 2 mΩ.cm and a phosphorus content of approximately from 700 to 770 ppm by the mass ratio of phosphorus to silicon.

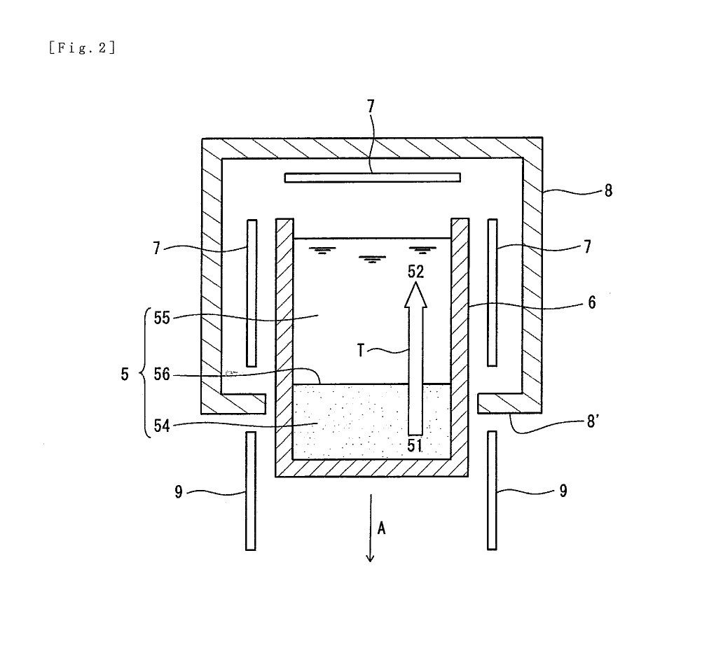

Then, the reduced silicon (5) in the heated and melted state after the addition of phosphorus is refined by a directional solidification method. The directional solidification method according to the present embodiment is carried out as shown in FIG. 2, in which the reduced silicon (5) in the heated and melted state is cooled in a mold (6) in the state where a temperature gradient (T) is provided in one direction.

Specifically, the mold (6) may preferably be inert to the reduced silicon (5) in the heated and melted state, and may preferably have heat resistance. Specifically, the mold (6) may preferably be formed, for example, of carbon such as graphite, silicon carbide, carbon nitride, alumina (aluminum oxide), or silica (silicon oxide) such as quartz.

In the example of FIG. 2, the temperature gradient (T) is set in the direction of gravity so that a lower temperature side (51) is placed on the lower side and a higher temperature side (52) is placed on the upper side. In this connection, the temperature gradient (T) only needs to be provided in one direction, and, for example, may be provided in the horizontal direction so that the lower temperature side (51) and the higher temperature side (52) are placed on the same level, or may be provided in the direction of gravity so that the lower temperature side (51) is placed on the upper side and the higher temperature side (52) is placed on the lower side. The temperature gradient (T) may usually be from 0.2° C./mm to 2.5° C./mm, preferably from 0.5° C./mm to 1.5° C./mm, because such a temperature gradient does not require excessive equipment and therefore is practical.

The temperature gradient (T) can be provided, for example, as follows: That is, a furnace (8) is open in a central portion of its lower portion (8′), and the mold (6) is placed in the furnace (8) so as to freely rise and fall through the central portion of the lower portion (8′). In the furnace (8), three heaters (7) are placed above and to the left and right sides of the mold (6). While the upper portion of the mold (6) is heated by the heaters (7), the lower portion of the mold (6) is cooled at the lower portion (8′) of the furnace (8). This makes it possible to provide a temperature gradient (T) in the direction of gravity so that the lower temperature side (51) is placed on the lower side and the higher temperature side (52) is placed on the upper side.

Examples of the method of cooling the lower portion of the mold (6) may include air cooling, and a method using water-cooled plates (9), depending on the temperature gradient (T). That is, a pair of the water-cooled plates (9) is placed below the furnace (8) so that the water-cooled plates (9) are opposed to each other across the mold (6). Each of the water-cooled plates (9) includes a circulation flow path in the plate body formed, for example, of stainless steel, and cools the lower portion of the mold (6) by circulating water in the circulation flow path.

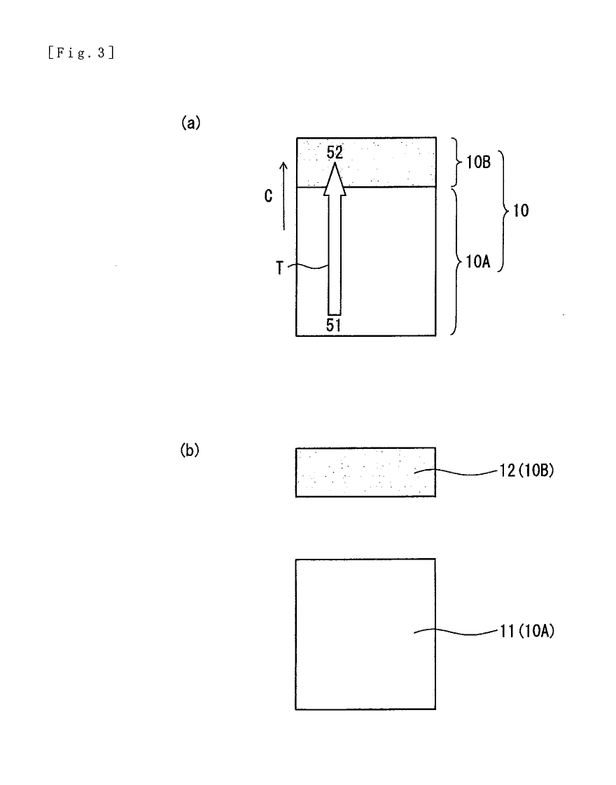

The cooling of the reduced silicon (5) in the heated and melted state is carried out by shifting the mold (6) that contains the reduced silicon (5) downward as shown by arrow A, and leading the mold (6) through the lower portion (8′) of the furnace (8) to the outside of the furnace (8). As a result, the reduced silicon (5) is solidified while forming a solid phase (54) from the lower temperature side (51), and, as shown in FIG. 3(a), becomes a directionally solidified silicon product (10).

The solidification velocity (R) may usually be from 0.05 to 2 mm/min, preferably from 0.4 to 1.2 mm/min, which solidification velocity (R) is expressed as the moving velocity of an interface (56) between the solid phase (54) formed from the lower temperature side (51) by the cooling and the liquid phase (55) placed on the higher temperature side (52) and not yet solidified. The solidification velocity (R) can be adjusted, for example, by the moving velocity of the mold (6) when the mold (6) is shifted to the outside of the furnace (8).

The reduced silicon (5) is gradually solidified from the lower temperature side (51), and the solidification rate (Y) in this solidification process is expressed as the proportion (%) of the reduced silicon having become the solid phase (54) to the entire reduced silicon (5) that has been used.

In the solidification process, impurities such as aluminum contained in the reduced silicon (5) move to the higher temperature side (52) while being segregated. Thus, in the directionally solidified silicon product (10) after the solidification, the impurity content (C) is increased in one direction from the lower temperature side (51) to the higher temperature side (52) of the temperature gradient (T). In contrast, the phosphorus contained in the reduced silicon (5) is unlikely to be segregated to the higher temperature side (52), and is relatively uniformly distributed in the solid phase (54) and the liquid phase (55).

FIGS. 3(a) and 3(b) are schematic views showing a process of obtaining the aluminum-containing silicon for n-type solar cells and the phosphorus-doped silicon according to one embodiment of the present invention. As shown in FIG. 3(a), in the obtained directionally solidified silicon product (10), the region placed on the lower temperature side (51) of the temperature gradient (T) in the cooling process serves as a refined silicon region (10A) having a small impurity content, and the region placed on the higher temperature side (52) serves as a crude silicon region (10B) containing a great amount of segregated impurities. The removal of the crude silicon region (10B) from the directionally solidified silicon product (10) makes it possible, as shown in FIG. 3(b), to obtain the desired phosphorus-doped silicon (11) made of the refined silicon region (10A).

The method of removing the crude silicon region (10B) is not particularly limited, but, for example, an ordinary method using a diamond cutter can be used. That is, crude silicon (12) made of the crude silicon region (10B) may be cut off along the interface between the refined silicon region (10A) and the crude silicon region (10B). The obtained phosphorus-doped silicon (11) is useful, for example, as a raw material for solar cells.

In particular, when the phosphorus-doped silicon (11) is silicon for n-type solar cells, the aluminum content in the silicon for n-type solar cells may be from 0.001 to 1.0 ppm, preferably from 0.03 to 0.3 ppm, and more preferably from 0.03 to 0.1 ppm, by the mass ratio of aluminum to silicon. When the aluminum content is lower than 0.001 ppm, it may become disadvantageous from an economical point of view. Further, when the aluminum content is greater than 1.0 ppm, characteristics as solar cells may be deteriorated.

Further, the phosphorus content may be from 0.0011 to 1.1 ppm, preferably from 0.3 to 0.8 ppm, by the mass ratio of phosphorus to silicon. When the phosphorus content is lower than 0.0011 ppm or greater than 1.1 ppm, characteristics as solar cells may be deteriorated.

Further, the mass concentration ratio of phosphorus to aluminum in the silicon for n-type solar cells may be 1.1 or greater, preferably from 1.1 to 20. When the mass concentration ratio of phosphorus to aluminum is smaller than 1.1, the obtained silicon becomes difficult to show n-type characteristics and the yield of the obtained silicon for n-type solar cells is also decreased. In this connection, the applications of the phosphorus-doped silicon according to the present invention are not limited to the application exemplified above.

Although a preferred embodiment of the present invention is described above, the present invention is not limited to the above embodiment, but there can be made various improvements and modifications in the scope of the claims. For example, in one embodiment described above, the case was described where reduced silicon is used as aluminum-containing silicon; however, the present invention is not limited thereto. Alternatively, another aluminum-containing silicon may be used, instead of reduced silicon, as a raw material.

Further, one embodiment described above, the case was described where the obtained reduced silicon is heated and melted, and phosphorus is added to the heated and melted reduced silicon. Alternatively, the reduced silicon may be refined by a directional solidification method and then may be heated and melted, and phosphorus may be added to the resulting product. That is, when a relatively great amount of aluminum is contained, it may not be possible to sufficiently remove aluminum in a single refinement process by a directional solidification method. Thus, when it is not possible to sufficiently remove aluminum in a single refinement process by a directional solidification method, that is, when it is necessary to carry out two or more refinement processes by a directional solidification method, silicon solidified in one direction and refined may be used as aluminum-containing silicon. This makes it possible to obtain silicon for n-type solar cells and phosphorus-doped silicon, from which aluminum has finally been removed to an appropriate degree by refinement.

Further, in one embodiment described above, the case was described where aluminum-containing silicon is heated and melted, and phosphorus is added so that a mass concentration ratio of phosphorus to aluminum becomes 0.009 or greater and then the resulting product is solidified in a mold in the state where temperature gradient is provided in one direction. Alternatively, phosphorus may be added to aluminum-containing silicon so that a mass concentration ratio of phosphorus to aluminum becomes 0.009 or greater and then the resulting product may be heated and melted, and may be solidified in a mold in the state where temperature gradient is provided in one direction.

The present invention will be described in more detail below using Examples; however, the present invention is not limited only to the following Examples.

### Example 1

### Production of Silicon for N-type Semiconductors

As shown in FIGS. 2 and 3, silicon for n-type semiconductors was obtained. Specifically, first, 10 kg of high-purity silicon (having a purity of 99.99999% or greater) and 0.1 g of high-purity aluminum (having a purity of 99.999%, available from Sumitomo Chemical Company, Limited), which was corresponding to 10 ppm, were placed in the mold (6) made of graphite as shown in FIG. 2 (having internal dimensions of 18 cm×18 cm×28 cm in depth and an internal volume of about 9 L), and were heated to 1,540° C. and melted in the electric furnace (8) having an argon gas atmosphere, whereby an aluminum-containing silicon melt having a melt depth of 130 mm was produced.

Then, phosphorus was added to the silicon melt so that a mass concentration ratio of phosphorus to aluminum in silicon became 0.03 and a phosphorus content in the silicon melt became 0.3 ppm by the mass ratio of phosphorus to silicon. The added phosphorus was a silicon-phosphorus master alloy, which is an alloy of high-purity silicon having a purity of 99.99999% by mass (seven nines) or greater and high-purity phosphorus having a purity of 99.9999% by mass (six nines) or greater. The silicon-phosphorus master alloy had a resistivity of 2 mΩ.cm and a phosphorus content of 770 ppm by the mass ratio of phosphorus to silicon.

Then, the aluminum-containing silicon melt was solidified in one direction by the directional solidification method of shifting the mold (6) in the direction of arrow A under the conditions of a temperature gradient (T) of 1° C./mm and a solidification velocity (R) of 0.4 mm/min, whereby the directionally solidified silicon product (10) as shown in FIG. 3 was obtained. In this connection, the temperature gradient (T) was provided in the direction of gravity so that the lower temperature side (51) was placed on the lower side and the higher temperature side (52) was placed on the upper side.

In the obtained directionally solidified silicon product (10), the portions corresponding to the interface (56) between the solid phase (54) and the liquid phase (55) formed when the solidification rate (Y) in the solidification process was 20%, 50%, and 80%, were cut with a diamond cutter, and the aluminum and phosphorus contents in each portion were determined by ICP mass spectrometry. The results are shown in Table 1. As can be seen from Table 1, the mass concentration ratio of phosphorus to aluminum in the directionally solidified silicon product (10) at each solidification rate (Y) is 1.1 or greater.

TABLE 1

| Solidification | Aluminum | Phosphorus | Mass concentration |
|---|---|---|---|
| rate (Y) | content | content | ratio of phosphorus |
| (%) | (ppm) | (ppm) | to aluminum |
| 20 | 0.03 | 0.12 | 4.0 |
| 50 | 0.05 | 0.16 | 3.2 |
| 80 | 0.12 | 0.29 | 2.4 |

### Example 2

First, in the same manner as describe above in Example 1, an aluminum-containing silicon melt having a melt depth of 130 mm was produced. Then, the directional solidification method was carried out in the same manner as described above in Example 1, except that phosphorus was added to the silicon melt so that a mass concentration ratio of phosphorus to aluminum in silicon became 0.07 and a phosphorus content in the silicon melt became 0.7 ppm by the mass ratio of phosphorus to silicon, whereby the directionally solidified silicon product (10) was obtained.

In the obtained directionally solidified silicon product (10), the portions corresponding to the interface (56) between the solid phase (54) and the liquid phase (55) formed when the solidification rate (Y) in the solidification process was 20%, 50%, and 80%, were cut with a diamond cutter, and the aluminum and phosphorus contents in each portion were determined by ICP mass spectrometry. The results are shown in Table 2. As can be seen from Table 2, the mass concentration ratio of phosphorus to aluminum in the directionally solidified silicon product (10) at each solidification rate (Y) is 1.1 or greater.

TABLE 2

| Solidification | Aluminum | Phosphorus | Mass concentration |
|---|---|---|---|
| rate (Y) | content | content | ratio of phosphorus |
| (%) | (ppm) | (ppm) | to aluminum |
| 20 | 0.04 | 0.28 | 7.0 |
| 50 | 0.06 | 0.38 | 6.3 |
| 80 | 0.15 | 0.68 | 4.5 |

### Comparative Example 1

First, in the same manner as describe above in Example 1, an aluminum-containing silicon melt having a melt depth of 130 mm was produced. Then, the directional solidification method was carried out in the same manner as described above in Example 1, except that phosphorus was added to the silicon melt so that a mass concentration ratio of phosphorus to aluminum in silicon became 0.003 and a phosphorus content in the silicon melt became 0.03 ppm by the mass ratio of phosphorus to silicon, whereby the directionally solidified silicon product (10) was obtained.

In the obtained directionally solidified silicon product (10), the portions corresponding to the interface (56) between the solid phase (54) and the liquid phase (55) formed when the solidification rate (Y) in the solidification process was 20%, 50%, and 80%, were cut with a diamond cutter, and the aluminum and phosphorus contents in each portion were determined by ICP mass spectrometry. The results are shown in Table 3. As can be seen from Table 3, the mass concentration ratio of phosphorus to aluminum in the directionally solidified silicon product (10) at each solidification rate (Y) is smaller than 1.1.

TABLE 3

| Solidification | Aluminum | Phosphorus | Mass concentration |
|---|---|---|---|
| rate (Y) | content | content | ratio of phosphorus |
| (%) | (ppm) | (ppm) | to aluminum |
| 20 | 0.03 | 0.01 | 0.3 |
| 50 | 0.05 | 0.01 | 0.2 |
| 80 | 0.13 | 0.03 | 0.2 |

### Comparative Example 2

First, in the same manner as describe above in Example 1, an aluminum-containing silicon melt having a melt depth of 130 mm was produced. Phosphorus was not added to the silicon melt. Then, the directional solidification method was carried out in the same manner as described above in Example 1, whereby the directionally solidified silicon product (10) was obtained.

In the obtained directionally solidified silicon product (10), the portions corresponding to the interface (56) between the solid phase (54) and the liquid phase (55) formed when the solidification rate (Y) in the solidification process was 20%, 50%, and 80%, were cut with a diamond cutter, and the aluminum and phosphorus contents in each portion were determined by ICP mass spectrometry. The results are shown in Table 4. As can be seen from Table 4, the mass concentration ratio of phosphorus to aluminum in the directionally solidified silicon product (10) at each solidification rate (Y) is smaller than 1.1.

TABLE 4

| Solidification | Aluminum | Phosphorus | Mass concentration |
|---|---|---|---|
| rate (Y) | content | content | ratio of phosphorus |
| (%) | (ppm) | (ppm) | to aluminum |
| 20 | 0.04 | 0.004 | 0.1 |
| 50 | 0.06 | 0.005 | 0.08 |
| 80 | 0.15 | 0.01 | 0.07 |

<Evaluation>

In the directionally solidified silicon products (10) obtained in Examples 1, 2 and Comparative Examples 1, 2, the portions formed at solidification rates (Y) of up to 80% were used as silicon for solar cells, and the resistivity, the lifetime, and the diffusion length were evaluated as the solar cell characteristics of each portion. The evaluation methods are described below, and the results are shown in Table 5.

(Resistivity and Lifetime)

First, a wafer having a square shape of 50 mm×50 mm and a thickness of 0.35 mm was cut out from the directionally solidified silicon product (10), using a wire saw. Then, the wafer was etched with hydrofluoric-nitric acid, and then the resistivity and the lifetime of the wafer were measured. The resistivity of the wafer was measured by the QSSPC (Quasi-Steady-State Photoconductance) method. As the measuring instrument, “TDS210” available from Tektronix, Inc. was used. The lifetime of the wafer was measured by the QSSPC method by immersing the wafer in an iodine-ethanol solution. As the measuring instrument, “TDS210” available from Tektronix, Inc. was used. Not a local lifetime of the wafer, but the average lifetime of the entire wafer was measured, using a white light source as the light source.

(Diffusion Length)

A substrate, 180 mm in width×130 mm in length×5 mm in thickness, having a cross-section parallel to the solidification direction was cut out from the directionally solidified silicon product (10), was etched with hydrofluoric-nitric acid, and was then subjected to oxidation treatment. Then, the diffusion length of the substrate was measured. The diffusion length of the substrate was measured by the SPV (Surface Photo Voltage) method. As the measuring instrument, “CMS4010” available from Semiconductor Diagnostics, Inc. was used.

TABLE 5

| | | | Mass | | | | |
|---|---|---|---|---|---|---|---|
| | | | concentration | | | | |
| | Aluminum | Phosphorus | ratio of | | | Diffusion | |
| | content | content | phosphorus to | Resistivity | Lifetime | length | Overall |
| | (ppm) | (ppm) | aluminum | (Ω · cm) | (μs) | (μm) | evaluation |
| Example 1 | from 0.03 to 0.12 | from 0.12 to 0.29 | from 2.4 to 4.0 | from 0.8 to 1.8 | 50 | 300 | excellent |
| Example 2 | from 0.04 to 0.15 | from 0.28 to 0.68 | from 4.5 to 7.0 | from 0.3 to 0.9 | 30 | 120 | good |
| Comparative | from 0.03 to 0.13 | from 0.01 to 0.03 | from 0.2 to 0.3 | from 3 to 23 | 50 | 40 | no good |
| Example 2 | | | | | | | |
| Comparative | from 0.04 to 0.15 | from 0.004 to 0.01 | from 0.07 to 0.1 | from 2 to 12 | 50 | 40 | no good |
| Example 1 | | | | | | | |

As can be seen from Table 5, Example 1 showed that the resistivity was from 0.8 to 1.8 Ω.cm, which indicates an n-type; the lifetime was 50 μs, except for the end portions of the directionally solidified product; and the diffusion length was 300 μm, except for the end portions of the directionally solidified product. From these results, it was determined that Example 1 was able to be used as silicon for n-type solar cells. Further, Example 2 showed that the resistivity was from 0.3 to 0.9 Ω.cm, which indicates an n-type; the lifetime was 30 μs, except for the end portions of the directionally solidified product; and the diffusion length was 120 μm, except for the end portions of the directionally solidified product. From these results, it was determined that Example 2 was able to be used as silicon for n-type solar cells.

On the other hand, Comparative Example 1 showed that the resistivity was from 3 to 23 Ω.cm, which indicates a p-type; the lifetime was 50 μs, except for the end portions of the directionally solidified product; and the diffusion length was 40 μm, except for the end portions of the directionally solidified product. From these results, it was determined that Comparative Example 1 was difficult to be used as silicon for n-type solar cells. Further, Comparative Example 2 showed that the resistivity was from 2 to 12 Ω.cm, which indicates a p-type; the lifetime was 50 μs, except for the end portions of the directionally solidified product; and the diffusion length was 40 μm, except for the end portions of the directionally solidified product. From these results, it was determined that Comparative Example 2 was difficult to be used as silicon for n-type solar cells.

As shown in FIGS. 1 to 3, the phosphorus-doped silicon (11) was obtained. Specifically, first, the reduced silicon (5) was obtained as shown in FIG. 1. The members used are as follows.

The silicon halide (1): silicon tetrachloride gas having a purity of 99.99% by mass or greater, a boron content of 0.1 ppm, and a phosphorus content of 0.3 ppm was used. The boron content and the phosphorus content are the mass ratio of boron to silicon and the mass ratio of phosphorus to silicon, respectively.

The metal aluminum (3): a commercially available electrolytically-reduced aluminum having a purity of 99.9% by mass or greater was used.

The blowing pipe (2): a pipe made of alumina and having an inner diameter of 8 mm was used.

The container (4): a container made of graphite and having an inner diameter of 180 mm and a depth of 200 mm was used.

As shown in FIG. 1, the silicon halide (1) was reduced by being blown through the blowing pipe (2) into the metal aluminum (3) in the heated and melted state at 1,020° C. In this connection, the amount of silicon halide (1) to be brown was 0.2 L/min.

The obtained aluminum melt (30) was cooled, and the crystallized silicon was cut out with a diamond cutter, whereby the reduced silicon (5) was obtained. The aluminum content of the reduced silicon (5) determined by ICP mass spectrometry was 1,080 ppm by the mass ratio of aluminum to silicon.

The reduced silicon (5) was subjected to acid washing by immersion in 36% of hydrochloric acid at 80° C. for 8 hours. With respect to the reduced silicon (5) after the acid washing, the aluminum and boron contents were determined by ICP mass spectrometry, and the phosphorus content was determined by GDMS. The aluminum content was 10.1 ppm by the mass ratio of aluminum to silicon; the phosphorus content was 0.08 ppm by the mass ratio of phosphorus to silicon; and the boron content was smaller than 0.015 ppm (detection lower limit) by the mass ratio of boron to silicon. The purity of the reduced silicon (5) after the acid washing was 99.99% by mass or greater.

Then, the reduced silicon (5) after the acid washing was introduced into the mold (6) as shown in FIG. 2, was melted by heating to 1,510° C., and was held in this state under a reduced pressure of 1 Pa (absolute pressure) for 12 hours. In this connection, as the mold (6), there was used one which was made of graphite and had an inner diameter of 40 mm and a depth of 200 mm.

Then, while the reduced silicon (5) remained in the heated and melted state, argon gas was introduced into the furnace (8) so as to have an atmospheric pressure, and phosphorus was added so that the phosphorus content became 0.6 ppm by the mass ratio of phosphorus to silicon. The added phosphorus was a silicon-phosphorus master alloy, which is an alloy of high-purity silicon having a purity of 99.99999% by mass (seven nines) or greater and high-purity phosphorus having a purity of 99.9999% by mass (six nines) or greater. The silicon-phosphorus master alloy had a resistivity of 2 mΩ.cm and a phosphorus content of 700 ppm by the mass ratio of phosphorus to silicon.

Then, the reduced silicon (5) was solidified in one direction by the directional solidification method of shifting the mold (6) in the direction of arrow A under the conditions of a temperature gradient (T) of 1° C./mm and a solidification velocity (R) of 0.4 mm/min, whereby the directionally solidified silicon product (10) as shown in FIG. 3 was obtained. In this connection, the temperature gradient (T) was set in the direction of gravity so that the lower temperature side (51) was placed on the lower side and the higher temperature side (52) was placed on the upper side.

In the obtained directionally solidified silicon product (10), the portions corresponding to the interface (56) between the solid phase (54) and the liquid phase (55) formed when the solidification rate (Y) in the solidification process was 20%, 50%, and 80%, were cut with a diamond cutter, and the aluminum and boron contents in each portion were determined by ICP mass spectrometry, and the phosphorus content in each portion was determined by GDMS. The results are shown in Table 6.

TABLE 6

| Solidification | Aluminum | Boron | Phosphorous |
|---|---|---|---|
| rate (Y) | content | content | content |
| (%) | (ppm) | (ppm) | (ppm) |
| 20 | 0.03 | <0.015 | 0.03 |
| 50 | 0.06 | <0.015 | 0.04 |
| 80 | 0.15 | <0.015 | 0.06 |

Reduced silicon (5) after acid washing:
Aluminum content, 10.1 ppm
Boron content, <0.015 ppm
Phosphorous content, 0.08 ppm

As can be seen from Table 6, it is understood that even when phosphorus is added to the heated and melted reduced silicon (5) and the resulting product is solidified in one direction, the distribution of phosphorus in the silicon after the solidification shows relatively small segregation. Further, it is understood that the desired phosphorus-doped silicon (11) made of the refined silicon region (10A) is obtained by cutting the obtained directionally solidified silicon product (10) at the portion corresponding to the interface (56) formed when the solidification rate (Y) in the solidification process is 80%, so as to cut off the crude silicon region (10B).

### Example 4

First, in the same manner as describe above in Example 1, the reduced silicon (5) before acid washing was obtained. Then, the reduced silicon (5) was introduced into the mold (6) as shown in FIG. 2, and was melted by heating to 1,540° C. Then, the reduced silicon (5) was solidified in one direction by the directional solidification method of shifting the mold (6) in the direction of arrow A under the conditions of a temperature gradient (T) of 1° C./mm and a solidification velocity (R) of 0.4 mm/min, whereby the directionally solidified silicon product (10) was obtained. In this connection, the temperature gradient (T) was provided in the direction of gravity so that the lower temperature side (51) was placed on the lower side and the higher temperature side (52) was placed on the upper side.

Then, the reduced silicon (5) was refined by cutting off, from the obtained directionally solidified product (10), the crude silicon region (10B) at the portion corresponding to the interface (56) formed when the solidification rate (Y) in the solidification process was 80%. The aluminum and boron contents in the refined reduced silicon (5) obtained as the refined silicon region (10A) were determined by ICP mass spectrometry, and the phosphorus content in the refined reduced silicon (5) was determined by GDMS. As a result, the aluminum content was 6.3 ppm by the mass ratio of aluminum to silicon; the phosphorus content was 0.03 ppm by the mass ratio of phosphorus to silicon; and the boron content was less than 0.015 ppm (detection lower limit) by the mass ratio of boron to silicon.

Then, the reduced silicon (5) refined as described above was introduced into the mold (6) as shown in FIG. 2, and was melted by heating to 1,540° C. Then, phosphorus was added so that the phosphorus content became 0.03 ppm by the mass ratio of phosphorus to silicon. Then, the reduced silicon (5) was solidified in one direction by the directional solidification method of shifting the mold (6) in the direction of arrow A under the conditions of a temperature gradient (T) of 1° C./mm and a solidification velocity (R) of 0.4 mm/min, whereby the directionally solidified silicon product (10) as shown in FIG. 3 was obtained. In this connection, the temperature gradient (T) was provided in the direction of gravity so that the lower temperature side (51) was placed on the lower side and the higher temperature side (52) was placed on the upper side.

In the obtained directionally solidified silicon product (10), the portions corresponding to the interface (56) formed when the solidification rate (Y) in the solidification process was 20%, 50%, and 80%, were cut with a diamond cutter, and the aluminum and boron contents in each portion were determined by ICP mass spectrometry, and the phosphorus content in each portion was determined by GDMS. The results are shown in Table 7.

TABLE 7

| Solidification | Aluminum | Boron | Phosphorous |
|---|---|---|---|
| rate (Y) | content | content | content |
| (%) | (ppm) | (ppm) | (ppm) |
| 20 | 0.05 | <0.015 | 0.02 |
| 50 | 0.08 | <0.015 | 0.03 |
| 80 | 0.16 | <0.015 | 0.03 |

Reduced silicon (5) after refinement:
Aluminum content, 6.3 ppm
Boron content, <0.015 ppm
Phosphorous content, 0.03 ppm

As can be seen from Table 7, it is understood that desired phosphorus-doped silicon (11) made of the refined silicon region (10A) is obtained by cutting the obtained directionally solidified silicon product (10) at the portion corresponding to the interface (56) formed when the solidification rate (Y) in the solidification process is 80%, so as to cut off the crude silicon region (10B).

### EXPLANATION OF NUMERALS

1 Silicon halide
2 Blowing pipe
3 Metal aluminum
4 Container
5 Reduced silicon
6 Mold
7 Heater
8 Furnace
9 Water-cooling plate
10 Directionally solidified silicon product
10A Refined silicon region
10B Crude silicon region
11 Phosphorous-doped silicon

1. Silicon for n-type solar cells, containing aluminum at a mass concentration of from 0.001 to 1.0 ppm and phosphorous at a mass concentration of from 0.0011 to 1.1 ppm, and having a mass concentration ratio of phosphorous to aluminum of 1.1 or greater.

2. The silicon according to claim 1, which is obtained by adding phosphorous to aluminum-containing silicon so that a mass concentration ratio of phosphorous to aluminum becomes 0.009 or greater, to obtain a mixture; heating and melting the obtained mixture to obtain a melted mixture; and solidifying the obtained melted mixture in a mold under a temperature gradient in one direction.

3. The silicon according to claim 1, which is obtained by heating and melting aluminum-containing silicon to obtain a melted product; adding phosphorous to the obtained melted product so that a mass concentration ratio of phosphorous to aluminum becomes 0.009 or greater, to obtain a melted mixture; and solidifying the obtained melted mixture in a mold under a temperature gradient in one direction.

4. A method of producing phosphorous-doped silicon, comprising:
preparing a melted mixture containing aluminum, phosphorous, and silicon, by heating and melting aluminum-containing silicon to obtain a melted product and then adding phosphorous to the obtained melted mixture, or by adding phosphorous to aluminum-containing silicon to obtain a mixture and then heating and melting the obtained mixture; and
then solidifying the melted mixture in a mold under a temperature gradient in one direction.

5. The method according to claim 4, wherein phosphorous is added so that a mass concentration ratio of phosphorous to aluminum becomes 0.009 or greater in the preparation of the melted mixture.

6. The method according to claim 4, wherein the aluminum-containing silicon is reduced silicon obtained by reducing a silicon halide with metal aluminum.

7. The method according to claim 4, wherein the aluminum-containing silicon is subjected to acid washing, and then heated and melted.

8. The method according to claim 4, wherein the aluminum-containing silicon is heated and melted under reduced pressure.

9. The method according to any of claims 4 to 8, wherein the aluminum-containing silicon is silicon refined by solidification in one direction.
